(19) United States
(12) Patent Application Publication
(10) Pub. No.: US 2015/0346450 A1
(43) Pub. Date: Dec. 3, 2015

(54) PIVOTABLY ATTACHABLE FIBER OPTIC HOUSING, MODULAR HOUSING SYSTEM AND METHOD

(71) Applicant: CORNING OPTICAL COMMUNICATIONS LLC, Hickory, NC (US)

(72) Inventors: Ray Samuel Barnes, JR., Hickory, NC (US); Trampus Lee Landrum, Hickory, NC (US); Jose Martinez Sanchez, Reynosa Tamaulipas (MX); Matthew Roy Miller, Lenoir, NC (US); Arturo Parra Morales, Reynosa Tamaulipas (MX); Adriana Montalvo Urbano, Reynosa Tamaulipas (MX)

(21) Appl. No.: 14/724,254

(22) Filed: May 28, 2015

Related U.S. Application Data
(60) Provisional application No. 62/004,510, filed on May 29, 2014.

(51) Int. Cl. G02B 6/44; G02B 6/38

(52) U.S. Cl. CPC G02B 6/4455; G02B 6/3897; G02B 6/4452

(57) ABSTRACT

A housing for fiber optic cable pivotably attachable to an adjacent housing to form a modular housing system is disclosed. The housing may include a first body having a plurality of members angled relative to one another to form a first chamber therebetween, the first body including an opening for receiving a fiber cable in the first chamber. An attachment feature may alternatively pivotably attach one of: a) a first cover to the first body to selectively enclose a first side of the first chamber in a cover state, or b) a second body of an adjacent housing to the first chamber to create a joint chamber involving a second chamber of the second body and the first chamber of the first body in an attached housing state.

### PRIORITY APPLICATION

This application claims the benefit of priority under 35 U.S.C. §119 of U.S. Provisional Application Ser. No. 62/004,510 filed on May 29, 2014, the content of which is relied upon and incorporated herein by reference in its entirety.

### BACKGROUND

1. Field

The disclosure relates generally to a fiber optic apparatus and more particularly to a housing, a modular housing system and a related method which may be used in, for example, local area network or fiber area network applications.

2. Technical Background

Benefits of optical fiber use include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection or junction points at which it is necessary to link optical fibers in order to provide “live fiber” from one connection point to another connection point.

The fiber optic connection equipment is oftentimes located in telecommunications enclosures such as weatherproof enclosures or telecommunication rooms, closets, hallways, etc. Fiber optic cables, particularly fiber optic cables containing multiple optical fibers, route to and between the telecommunications enclosures to allow for interconnections to other equipment in the network. In local area network (LAN) applications, people may use wall mount fiber optic housings in telecommunications rooms to provide fiber connectivity to their LAN applications. In fiber area network (FAN) applications, people may install small fiber optic housings inside of another box such as a weatherproof enclosure, e.g., a Hoffman model NEMA 4× outdoor rated enclosure, such as found at traffic lights, or cross connect systems in mining and oil operations. In some cases, standard wall mount housings are too large to place in small, space constrained areas such as weatherproof enclosures. In these types of applications, a smaller wall mount housing is used such as a single-panel housing such as model SPH-01P, available from Corning Optical Communications LLC. The single panel housing is a compact fiber optic housing that provides flexibility over the standard, larger sized wall mount housings.

Despite the availability of compact fiber optic housings, space management remains a challenge. In particular, additional space for expansion purposes may not be available or additional space may be expensive, e.g., in a telecommunications room in an office building. Even where space is available, the addition of new fiber optic housings may create an accessibility issue to previously installed equipment. Designing a fiber optic cable housing so as to maximize the use of space, while, at the same time, limiting the quantity of equipment and maintaining accessibility, is desired.

### SUMMARY

One embodiment of the disclosure relates to a housing for fiber cable components. The housing may include a first body having a first chamber, the first body including an opening for receiving a fiber optic cable in the first chamber. An attachment feature may alternatively pivotably attach one of: a) a first cover to the first body to selectively enclose a first side of the first chamber in a cover state, or b) a second body of an adjacent housing to the first housing in an attached housing state such that a joint chamber comprising a second chamber of the second body and the first chamber of the first body is created.

An additional embodiment of the disclosure relates to a modular housing system for fiber cable junctions. The system includes at least two modular housings. Each modular housing may include a first body including a plurality of members angled relative to one another to define a first chamber therebetween, the first body including an opening for receiving a fiber cable in the first chamber. A first cover may be removably coupled to the first body to selectively enclose a first side of the chamber. An attachment feature may pivotably attach one of: a) a second cover to the first body to selectively enclose a second side of the first chamber in a cover state, or b) a second body of an adjacent modular housing to the first chamber to create a joint chamber between a second chamber of the second body and the first chamber of the first body in an attached housing state.

A further embodiment of the disclosure may include a method. The method may include providing a first modular housing and a second modular housing. Each modular housing may include: a body including a plurality of members angled relative to one another to form a chamber therebetween, the body including an opening for receiving a fiber cable in the chamber; a first cover removably coupled to the body to selectively enclose a first side of the chamber, and an attachment feature on the body for pivotably attaching a second cover to the body for selectively enclosing a second side of the chamber. The method may further include removing the first cover from the body of the first modular housing; removing the second cover from the body of the second modular housing; and forming a first attached housing system by pivotally attaching the body of the first modular housing to the body of the second modular housing using the attachment feature of one of the first and second modular housings.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a front, perspective view of one embodiment of a modular housing in a closed position.

FIG. 2 is a front, perspective view of the modular housing of FIG. 1 in an open position.

FIG. 3 is a front, perspective, exploded view of the modular housing of FIG. 1.

FIG. 4 is a rear, perspective, exploded view of a modular housing system including a pair of modular housings.

FIG. 5 is a rear, perspective view of the modular housing system of FIG. 4 in a closed position.

FIG. 6 is a front, perspective view of the modular housing system of FIG. 4 in a closed position.

FIG. 7 is a front, perspective view of the modular housing system of FIG. 4 in an open position.

FIG. 8 is a front, perspective view of a modular housing system including three modular housings, each in an open position.

### DETAILED DESCRIPTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

The terms “optical fibers”, “fiber cables” and “fiber optic cables” include all types of single mode and multi-mode light waveguides, including one or more optical fibers that may be uncoated, colored, buffered, ribbonized and/or have other organizing or protective structure in a cable such as one or more tubes, strength members, jackets or the like. An example of a fiber optic cable is MIC® cable provided by Corning Optical Communications LLC. Likewise, other types of suitable optical fibers include bend-insensitive optical fibers, or any other expedient of a medium for transmitting light signals. An example of a bend-insensitive optical fiber is ClearCurve® Multimode fiber commercially available from Corning Incorporated.

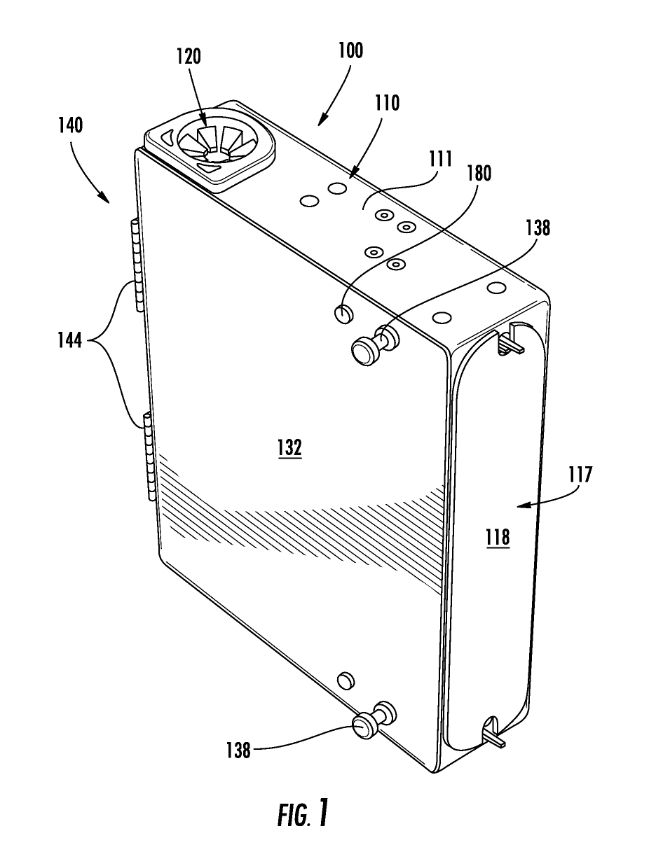

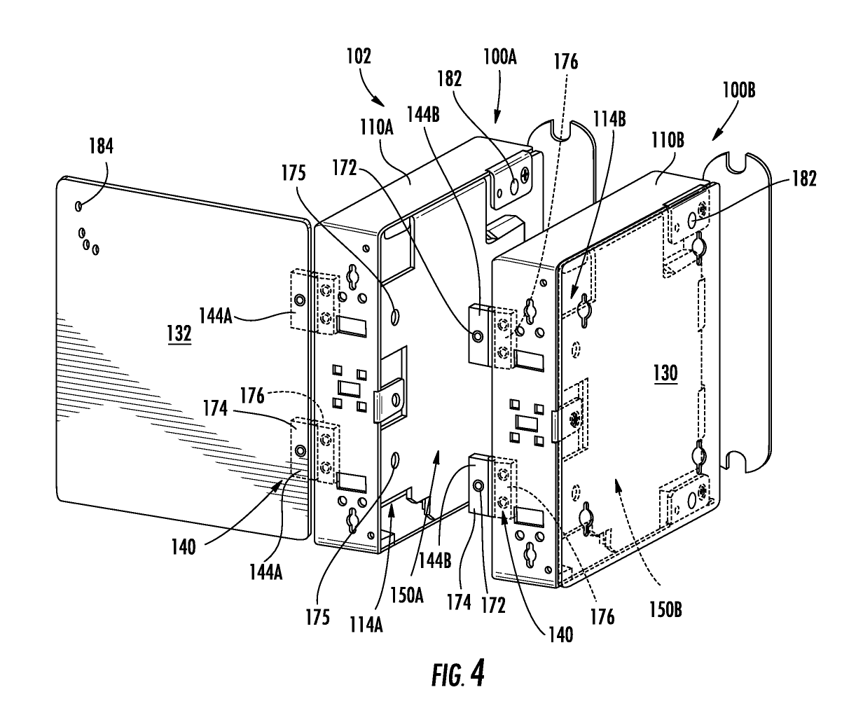

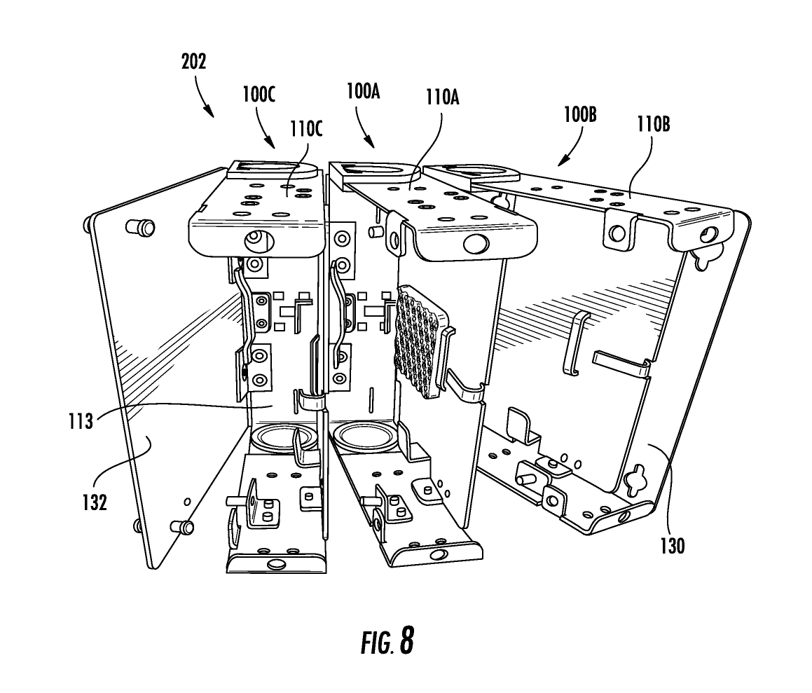

Embodiments disclosed in the detailed description include a housing for fiber optic cable and fiber optic cable connections and junctions, a modular housing system including a number of pivotably attachable housings and a related method. FIGS. 1-3 show a pivotably attachable fiber optic modular housing 100 (hereinafter simply “housing”) and designated generally throughout by reference numeral 100 or, where more than one is illustrated, 100A, 100B, 100C, et seq. FIGS. 4-7 show one embodiment of a modular housing system 102 including a pair of housings 100A, 100B, and FIG. 8 shows another embodiment of a modular housing system 202 including three housings 100A, 100B, 100C.

Housing 100 provides strain-relieving, storage, protection, splicing connection and termination for fiber optic cables. In addition, housing 100 offers protection for the fiber optic cable, splices and connectors for cabinet and/or indoor wall-mount or Deutsches Institut für Normung (DIN) rail mount installations. Housing 100 has narrow members which may be in the form of one or more of opposing top and bottom sides, and opposing first end and second end sides. Top, bottom and end sides may be approximately 1.5 inch wide from edge to edge, or may be any other suitable dimension. Additionally, each housing 100 may include a rear, broad side cover and a front, broad side cover each of which are removable. Rear broad side cover and front broad side cover each may be approximately 5.2 inches, or may be any other suitable dimension. Housing 100 may also include a built-in component holder. The component holder may include, for example, a splice organizer to hold and organize optical fiber splices, and routing guides to manage fiber optic cable in the chamber, including segregating buffer tubes or jacketed cable when splicing. The component holder may be physically fixed into housing.

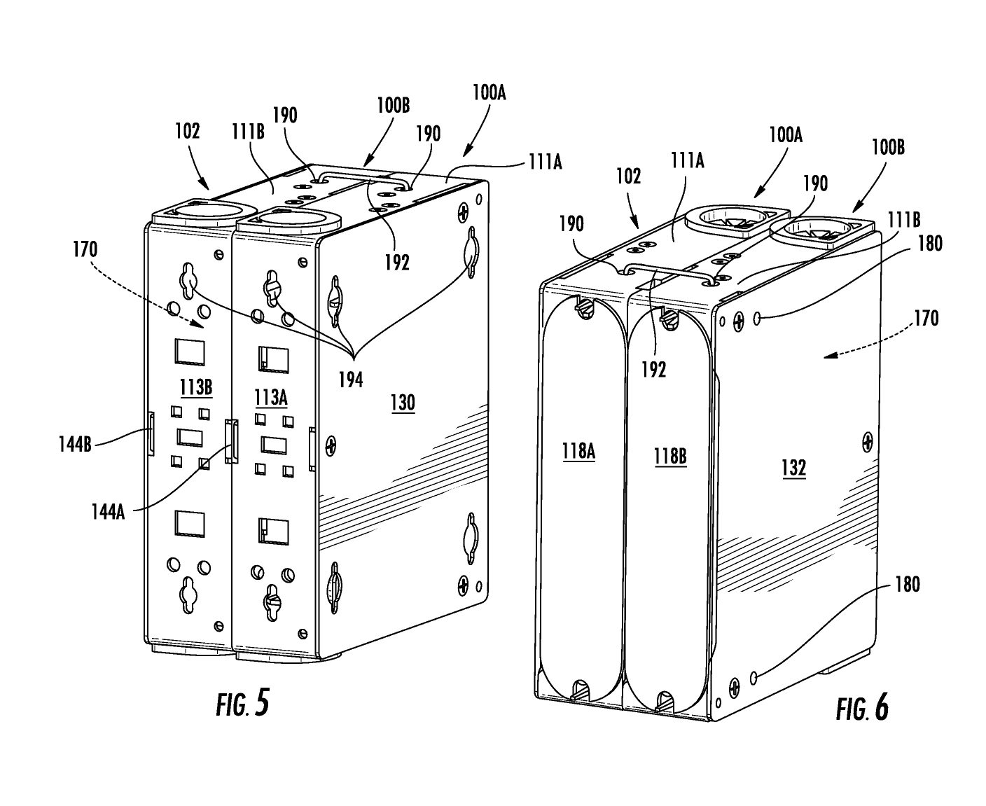

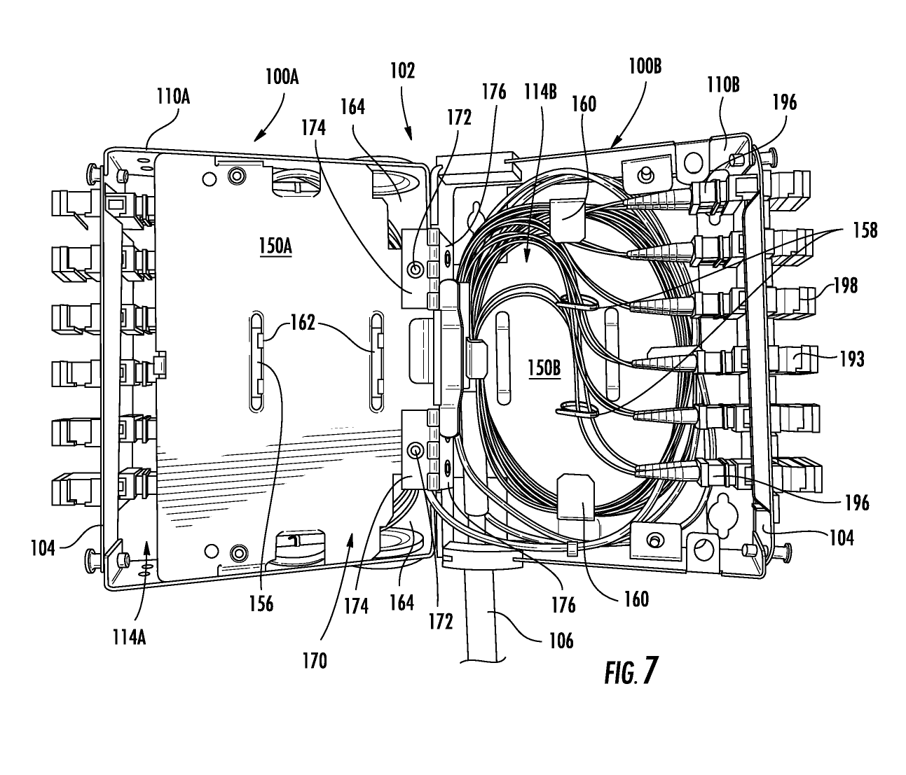

Housing 100 can function as a single unit that is wall or DIN rail mountable on either an end side or a cover side thereof, or individual housings 100 can be pivotably attached to each other to create a modular housing system (see, e.g., 102 in FIGS. 5-6). The attachment feature allows a user to begin a project with a small, single housing and then add capacity to accommodate system or network growth by pivotably attaching housings, thus allowing the user to increase their capacity. Each housing is designed to hold up to, for example, 24 fibers (typically 12) with an adapter panel configuration. The housing will allow multiple single and multi-fiber connector and adapter types, including, as non-limiting examples, SC, LC, MPO, etc. Front cover and rear cover may be removable. Additionally, one or both of front cover and rear cover may be pivotably attachable to housing by any suitable attachment feature or mechanism, for example, a hinge element. Once the front cover is removed at its attachment feature from a first housing and the rear side cover is removed from a second housing, screw holes on the first housing are used to screw/fasten to the exposed holes on the rear of the second housing allowing them to be pivotably attached together. The attachment feature allows a housing to be pivotably attachable such that two or more housings may form and function as a pivotably attachable modular housing system that allows for additional internal space compared to a single housing, but with minimal additional external space usage and easy access into either of the two housings that are mounted together.

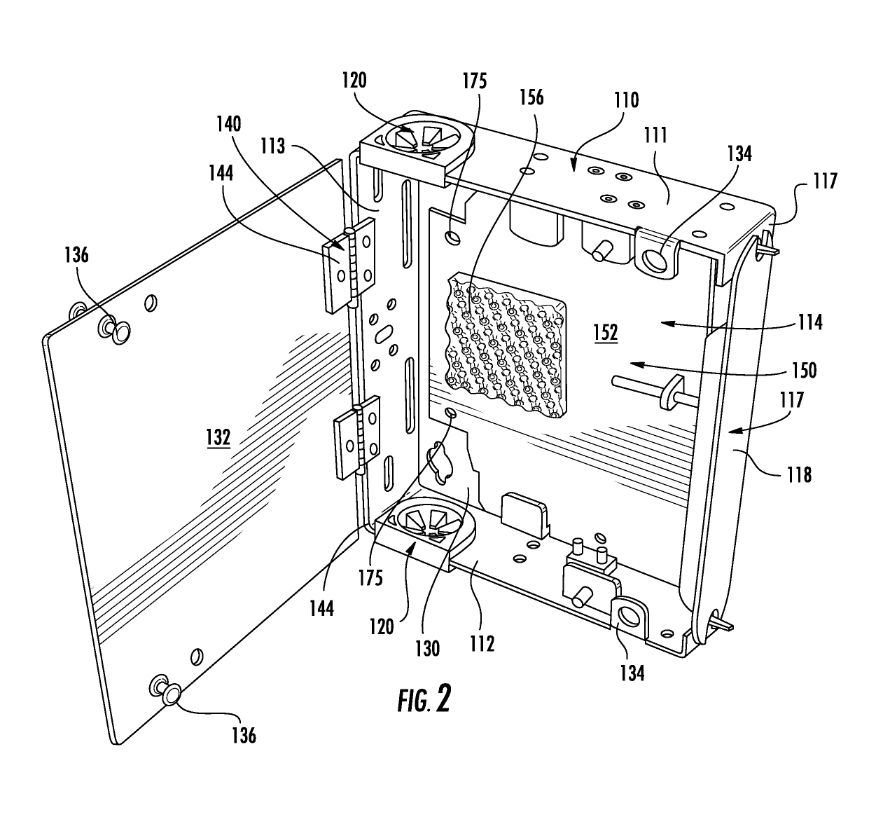

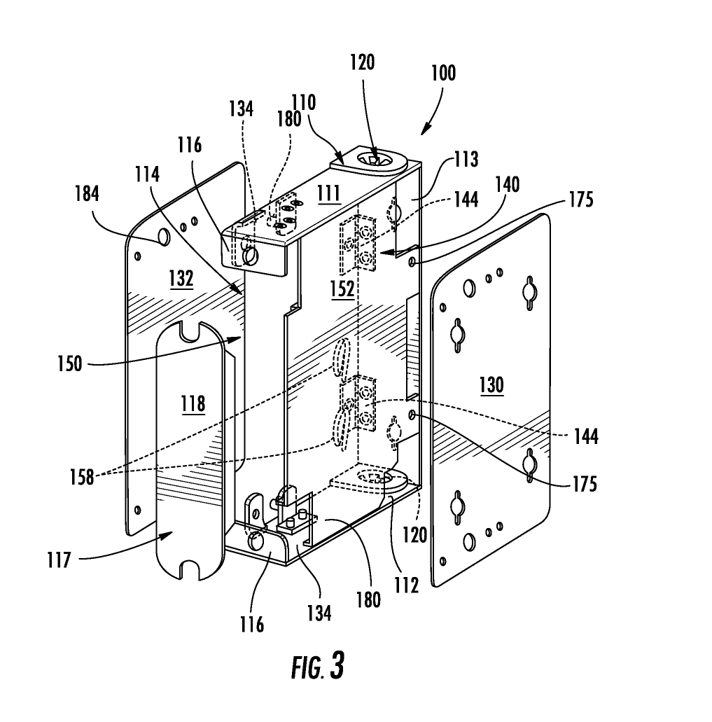

Referring to the drawings, a housing 100 will now be described. As shown in FIGS. 1-3, and shown best in the exploded view of FIG. 3, housing 100 may include a body 110 including a plurality of members including, one or more of top side 111, bottom side 112, first end 113 and second end 117 angled relative to one another to define a chamber 114 therebetween. Top side 111, bottom side 112, first end side 113 and second end side 117 may be separate members that are coupled together, for example, via welding, or may be bent into shape from a single piece of material such as a metal. Additionally, one of the first end side 113 and second end side 117 may comprise a cover or a plate. In any event, top side 111, bottom side 112, first end side 113 and second end side 117 create a chamber 114 into which one or more fiber optic cable(s) 106 (FIG. 7 only) may be one or more joined, connected and routed. In this manner, chamber 114 may be in the form of a rectangular space. While chamber 114 is illustrated as being created by top side 111, bottom side 112, first end side 113 and second end side 117, it is understood that a larger number of members may be employed to accommodate different shapes of housings, if desired. For example, housing 100 may include more members to accommodate a non-rectangular mounting space. As illustrated, top side 111 and bottom side 112 that form opposing sides of chamber 114 may terminate in a cover mounting tab 116 for securing a removable end cover 118 or a removable adapter panel 104 (FIG. 7 only) to one of first end side 113 and second end side 117. In FIG. 1-3, end cover 118 or panel 104 encloses second end side 117 of chamber 114. Mounting tabs 116 form a portion of at least one of first end side 113 and second end side 117 and may be separate members that are coupled to one or both of top side 111 and bottom side 112, for example, via welding, or may be bent into shape from a single piece of material with one or both of top side 111 and bottom side 112. End cover 118 may be coupled to mounting tabs 116 using any now known or later developed fastener, for example, extendable plunger-with-opening fastener (shown), screws, hook-and-latch fasteners, releasable snap fasteners, etc. In the plunger-with-opening fastener embodiment, an extendable, plastic plunger (example shown in FIG. 2 as 136) is provided for mating with a corresponding opening of tab 116 on body 110.

Body 110 may also include an opening 120 for receiving fiber cable 106 (FIG. 7). As illustrated, an opening 120 may be provided in each top side 111 and bottom side 112. However, opening(s) 120 may be provided in any of a number of locations about top side 111 or bottom side 112. Each opening 120 may include a cable entry grommet (not numbered) for chamber 114 access and environmental sealing about the fiber optic cable. The terms “top” and “bottom” have been used herein to differentiate between opposite sides as they are illustrated in the figures. It is emphasized that their ultimate relative positions are determined by the position of housing 100. Consequently, the sides relative positions may be switched, or the housing(s) may be positioned such that the sides do not necessarily result in a conventional ‘top’ and ‘bottom’ disposition.

Each housing 100 also may include a first or rear cover 130 removably coupled to body 110 to selectively enclose a first (broad) side of chamber 114, and a second or front cover 132 removably coupled to body 110 to selectively enclose a second (broad) side of chamber 114. The terms “rear” and “front” have been used herein to differentiate between covers as they are illustrated in the figures. It is emphasized that their ultimate relative positions are determined by the position of housing 100. Consequently, the covers relative positions may be switched, or the housing(s) may be positioned such that the covers do not necessarily result in a conventional ‘front’ and ‘rear’ disposition.

Rear cover 130 may be coupled to body 110 using any now known or later developed connector allowing removability, as examples, extendable plunger-with-opening fastener (shown), screws, hook-and-latch fasteners, releasable snap fasteners, etc. Similar to tabs 116, tab(s) 134 with an opening therein may be provided on one or both top side 111 and bottom side 112 for mating reception with various types of fasteners on a cover(s) 130, 132. For example, as shown best in FIG. 2 relative to front cover 132, a plunger 136 may mate with a corresponding opening of tab 134 to secure front cover 132. A similar arrangement may be provided for rear cover 130. That is, each cover 118, 130, 132 (and adapter plate 104 (FIG. 7)) may include a plunger-type fastener for mating with body 110. As shown in FIG. 1, one or more pulls 138 may be provided to allow a user to remove plunger 136 from a respective opening in tab 134. Alternatively, cover(s) 130, 132 may have a flush surface with no pulls 138, requiring a tool such as a screwdriver to remove plunger 136 from tab 134. It is understood that the plunger-with-opening fastener is just one example of a removable fastener that could be used for the various covers. For example, FIGS. 5 and 6 show an alternative embodiment in which each cover 130, 132 is secured with screws.

As will be described in greater detail herein and shown in FIGS. 2-4, each front cover 132 is also pivotably attached to body 110 by an attachment feature, such as a hinge element 140 such that it may pivot between a closed position, shown in FIG. 1, and an open position, shown in FIG. 2. The open position provides access to chamber 114, allowing work to be completed to fiber optic cable 106 (FIG. 7) therein.

Referring to FIGS. 2 and 3, housing 100, and in particular body 110, may also include a component holder 150 mounted in chamber 114. Alternatively, where more than one housing 100 is employed, a component holder 150 may be employed in one or more chambers 114 of housings 100 in modular housing system 102 (FIGS. 4-7), 202 (FIG. 8). In one embodiment, as shown best in FIGS. 2 and 3, component holder 150 may include a plate 152 mounted to one or both of top side 111 and bottom side 112. Plate 152 may be mounted using any now known or later developed fastener such as screws, welding, male-female fasteners, etc. Plate 152 may be fixed or selectively removable. Plate 152 may be used alone or may include at least one component mounted thereon. A component holder 150 may hold any variety of components, such as but not limited to: a splice organizer 156, for example, in the form of a plastic or rubber member with plurality of prongs thereon (FIG. 2); cable tie downs 158 (FIG. 3) (for example, hook-and-latch fasteners); and/or routing guides 160 (FIG. 7). Each component may be physically affixed to plate 152. For example, as shown best in FIG. 7, a splice organizer 156 may be physically fixed via a snap fit into opening(s) 162 in plate 152. As also shown best in FIG. 7, component holder 150 may also include a passage 164 allowing at least part of fiber optic cable 106 to pass from a chamber 114B of body 110B of housing 100B to second chamber 114A of second body 110A of pivotably attached housing 100A. Each component holder 150 may also include a number of openings 175 (see e.g., FIG. 3) for coupling an attachment feature, such as hinge 144, of an adjacent housing thereto, as will be described in greater detail herein.

As explained and according to certain embodiments, plate 152 may include or embody rear cover 132, eliminating the need for separate plate 152 and rear cover 132. In these embodiments, plate 152 may be configured for “quick-release” removal using plunger, tabs, or other quick-release fastening mechanism. It is contemplated that covers 132 may be fastened to one or more other components of housing 100 (or modular housing system 102) using “quick-release” fastening using, for example, plungers, snap-locks, clips, or other suitable “quick-release” fastening system.

Turning to FIGS. 4-8, a modular housing system 102 (FIGS. 4-7), 202 (FIG. 8) will now be described. In FIGS. 4-8, reference numbers of FIGS. 1-3 are used for like structure but with letter designations A, B, C, etc., to differentiate between housings. (Note, modular housing system 102 of FIGS. 4-6 opens to the right as one faces front cover 132, while that of FIGS. 7 and 8 opens to the left as one faces front cover 132.)

Turning to FIG. 4, each housing 100A, 100B also includes an attachment feature such as a hinge element 140. Each hinge element 140 is operative to pivotably attach either, as shown in FIGS. 1-3, a second, front cover 132 or, as shown in FIGS. 4-7, a second body 110B of another, second and adjacent housing 100B to body 110A of first housing 100A. In other words, attachment feature may be configured to selectively, alternatively pivotably attach one of a cover 130, 132 to a housing 100 or one housing 100A to another housing 100B. That is, attachment feature, such as hinge element 140, may pivotably attach, in a “cover state”, second, front cover 132 to body 110A to selectively enclose a second side of chamber 114A. Alternatively, in an “attached housing state,” a hinge element 140 may pivotably attach second body 110B of an adjacent housing 110B to body 110A to create a joint chamber 170 (FIGS. 5-7) involving second chamber 114B of second body 110B and first chamber 114A of first body 110A. Joint chamber 170, as shown in FIG. 7, may be divided by component holder 150A of the forwardmost housing 100A, where provided.

In one embodiment, hinge element 140 includes a pair of hinges 144A, 144B; however, other number of hinges 144 or other mechanisms may be employed. For example, FIG. 5 shows an embodiment including a single hinge 144A, 144B; however, three, four or more are possible. Each hinge 144, as shown in FIG. 4, may include a pair of pivoting plates 174, 176. As observed best by comparing FIGS. 3 and 7, each hinge 144 may include a threaded opening 172 for receiving a threaded connector (not numbered) from one of the second cover 132 (FIGS. 3) or second body 110A (FIG. 7). In the embodiments shown in FIGS. 4 and 7, hinge plate 174 is coupled to body 110A by component holder 150A thereof. In an alternative embodiment, hinge plate 174 may be coupled to first end side 113 in the attached housing state. Threaded opening 172 may be formed, for example, by threading an opening in the respective hinge plate 174 or by coupling a threaded member onto the hinge plate 174. Threads could also be provided in the opening in body 110 as an alternative, or in addition, to threaded opening 172, if desired. An opposing hinge plate 176 may be coupled to a respective body 110B by any appropriate means such as but not limited to screws, spot welding, etc.

In the field, a first housing and a second housing are provided as illustrated in FIGS. 1-3. As shown in FIG. 4, first (front) cover 132 is removed from body 110B of a first housing 100B, e.g., by removing screw(s) from hinges 144B thereof and removing any plunger, screws or other fasteners that hold first cover 132 on housing 100B. First cover 132 of body 110B is not shown in FIG. 4 as it is not used. Also, second (rear) cover 130 is removed from body 110A of second housing 100A. Second cover 130 of body 110A is not shown in FIG. 4 as it is not used. A first modular housing system 102 (FIGS. 5-7) may then be formed by pivotably attaching body 110B of first housing 100B to body 110A of second housing 100A using attachment feature, such as hinge element 140, of one of the first and second housings, for example, of housing 100B in FIG. 4.

Each housing 100A, 100B may also include an aligner that acts to properly align housings during attachment. In one embodiment, the aligner may include, as shown in FIG. 3, a first element 180 on a first body (110 in FIG. 3) for mating with a second element 182, as shown in FIG. 4, on an opposing side of a second body (110A and 110B in FIG. 4) of the adjacent housing. In the example shown, first element 180 includes a pin that extends from body 110 and second element 182 includes an opening (on a tab extending from one or both of top side 111 and bottom side 112) for receiving the pin. When the pin(s) is/are seated in the opening(s), the aligner acts to properly align each housing 100A, 100B such that hinges 144 can be easily coupled to a respective body, for example, hinges 144B to body 110A in FIG. 4. More specifically, referring to FIG. 4, in response to housing 110B being aligned and brought together with housing 110A, first element 180 (not in FIG. 4, see FIG. 3) of housing 110B engages second element 182 of housing 110A. In this position, threaded opening 172 of hinge plate 174 of each hinge 144B is automatically aligned with an opening 175 in component holder 150A of body 110A for easy connection of a fastener (e.g., screw) to pivotably attach housings 100A, 100B together. The aligner continues to act to maintain alignment once housings 100A, 100B are attached. As illustrated in FIG. 3, the aligner elements 182 are provided on one or both of opposing top sides 111 and bottom sides 112 of each body 110; however, this may not be necessary in all instances. For example, where another structure acts to retain one or both housings in aligned position for pivotable attachment, only one aligner may be provided. In the cover state, where cover 130 or 132 is used, first element 180, for example, a pin, may mate with a third element 184 of the respective cover that is similar to element 182, for example, an opening. It is understood that a wide variety of other mechanisms may be employed to ensure alignment of the two housings, as examples, a reversed setting of pin and opening, a protrusion and seat rather than a pin with opening, elements that mate with an outer surface of a body 110, etc.

As shown in FIGS. 5 and 6, each body 110 may include a fastener opening 190 for receiving a removable fastener 192 for preventing the bodies from moving apart in the attached housing state. Fastener 192 may include any pliable fastener member such as but not limited to, a plastic tie fastener, a metal wire, etc. Although openings 190 are illustrated in adjacent top sides 111A, 111B, they may be provided in a number of locations on bodies 110A, 110B.

As shown in FIG. 8, the above process of pivotably attaching a housing 100 may be repeated to pivotally attach as many housings 100 as desired. For example, relative to FIG. 8, a third housing 100C may be provided. After forming first modular housing system 102, as shown in FIG. 7, a selected cover 130 or 132 from body 110A or 110B of a selected housing 100A, 100B may be removed. In FIG. 8, cover 132 of housing 100A is removed. Also, an opposing cover 132 or 130 from body 110C of third housing 100A from that of selected cover 130 or 132 of selected housing 100A or 100B may be removed. In FIG. 8, rear cover 130 from body 110C was removed. A second modular housing system 202 may then be formed by pivotably attaching body 110C of third housing 100C to body 110A or 110B of selected housing 100A or 100B using a hinge element 140 of one of third housing 110C and the selected housing 100A or 100B. In FIG. 8, the attachment feature, in this embodiment hinge element 140, from body 110A was used to pivotably attach body 110C. It is understood that a new housing 100C could be pivotably attached to the front or the rear of modular housing system 102.

As an alternative or in addition to the stackable mounting via the front and rear panels, it is contemplated that the modules may be stacked via the top and/or edge-to-edge panels, in a similar manner as described above with respect to the front and rear panel.

Further, it is understood that each housing 100 can be pivotably attached prior to mounting of an initial housing 100, or to an in-place, mounted housing 100 or modular housing system 102, 202. Once all the housings are pivotably attached and covers replaced, additional fasteners such as screws may be added for added rigidity and security.

Housing 100 or modular housing system 102, 202 may be mounted to a fixed support using any now known or later developed mechanism. For example, first end 113 and/or rear cover 130 may include any now known or later developed coupling for mounting housing 100 to a fixed support, for example, standard surface mount, DIN rail, surface mount without screws or penetration of the mounting surface, base and spine mounts for DIN rails including vertical and horizontal mounting capabilities, etc. In the example shown in FIG. 5, first end 113 and rear cover 130 include a number of eyelets 194 capable of receiving a mounting screw or bolt from the fixed support for hanging the respective housing, or coupling to some other mounting mechanism.

As shown in FIG. 7, in the field, fiber optic cable 106 may be inserted into a selected chamber, for example, 114B of body 110B, of one of first and second housings 100A, 100B. At least part of fiber optic cable 106, for example, individual fiber(s) or buffer tube(s), from selected chamber 114A, 114B may then be passed through passage 164 in component holder, for example, 150A, of the other housing 100A and into chamber 114A of body 110A of the other housing 100A. In this manner, additional capacity of an added housing can be realized. An additional adapter panel 104 (FIG. 7) can also be used. Additionally, in FIG. 7 fiber optic cables 106 are shown terminated with connectors 196 and inserted into one end of adapters 198 extending through adapter plate 104.

Alternatively or additionally to fiber optic cable 106 being included within one or more chambers 114, it is contemplated that additional and/or different components. For example, modular housing system 102 may include one or more splitters, couplers, wavelength division multiplexing components/device, or any other suitable combination of communication components.

As shown in FIGS. 7 and 8, modular housing systems 102, 202 include pivotably attached housings 100A and 100B (FIG. 7) and 100A. 100B and 100C (FIG. 8). Modular housing system 102 including a pair of pivotably attached housings 100A, 100B doubles the fiber optic connector capacity of the single, standalone housing 100 (FIGS. 1-3), while modular housing system 202 triples the capacity. The addition of component holder 150 provides additional component mounting space and fiber optic cable organization within each housing and adds rigidity to the housing itself. Modular housing systems 102, 202 provide additional capacity without an extensive addition of space, and also allow for continued access by way of the pivotably attached relationship between housings. In addition, systems 102, 202 provide the above functionality while keeping fibers away from the mounting mechanism, and protect the fibers from “popping” out and getting pinched by a cover.

Housing 100 may be made of any conventional materials such as plate metal, as example, steel or a composite material, for example, plastic. End cover 118 may be made of a composite material such as plastic.

Although modular housing systems 102, 202 have been illustrated with attachment feature such as hinge element 140 on a vertical line, it is understood that the teachings of the disclosure can be applied equally to where attachment feature such as hinge element 140 is provided on a horizontal line, for example, coupled to one of top side 111 and bottom side 112. Also, it is noted that where it is known that a housing 100 will be used in an attached manner, one or more of the covers 130, 132 may be omitted entirely from housing 100.

It is contemplated that the dimensions of modular housing system 102 may be selected so that they are proportional to one another. For example, the height and width may be selected as a multiple of a depth (e.g., height may be 3-times the depth, the width may be 2-2.5 times the depth).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A housing for fiber optic cable components, the housing comprising:
a first body having a first chamber, the first body including an opening for receiving a fiber optic cable in the first chamber; and
an attachment feature configured to alternatively pivotably attach one of: a) a first cover to the first body to selectively enclose a first side of the first chamber in a cover state, and b) a second body of an adjacent housing to the first housing in an attached housing state such that a joint chamber comprising a second chamber of the second body and the first chamber of the first body is created.

2. The housing of claim 1, wherein the first body includes a plurality of members that define the first chamber.

3. The housing of claim 2, wherein the plurality of members comprise at least one of a top side, a bottom side, a first end side and a second end side.

4. The housing of claim 3, wherein the second end side comprises one of an end cover removably coupled to the first body to enclose the second end side of the first chamber and an adapter panel removably coupled to the first body to enclose the second end side of the first chamber.

5. The housing of claim 1, further comprising a component holder mounted in the first chamber.

6. The housing of claim 5, wherein the component holder includes a plate mounted to a pair of opposing members of a plurality of members defining the first chamber.

7. The housing of claim 6, wherein at least one component is mounted to the plate.

8. The housing of claim 5, wherein the component holder includes a plate mounted to a pair of opposing members of the body and at least one component mounted to the plate.

9. The housing of claim 5, wherein the component holder includes a passage configured to allow at least part of the fiber optic cable to pass from the first chamber of the first body to the second chamber of the second body.

10. The housing of claim 1, wherein the attachment feature includes a hinge element.

11. The housing of claim 10, wherein the hinge element includes a threaded opening for receiving a threaded connector from the one of the cover and the second body.

12. The housing of claim 10, wherein the hinge element includes a pair of hinges.

13. The housing of claim 1, further comprising a second cover removably coupled to the first body to selectively enclose a second side of the first chamber.

14. The housing of claim 1, wherein the first cover includes a plunger-type fastener for mating with a corresponding opening of the body.

15. The housing of claim 1, wherein each body includes a fastener opening for receiving a removable fastener configured to prevent the first body from moving apart from the second body in the attached housing state.

16. The housing of claim 1, further comprising an aligner including a first element on the first body configured for mating with a second element on an opposing side of the second body of the adjacent housing.

17. The housing of claim 16, wherein the first element mates with a third element of the second cover in the cover state.

18. A modular housing system for fiber cable junctions, the system comprising:
at least two modular housings, each modular housing including:
a first body including a plurality of members angled relative to one another to form a first chamber therebetween, the first body including an opening for receiving a fiber cable in the first chamber;
a first cover removably coupled to the first body to selectively enclose a first side of the chamber; and
an attachment feature for pivotably attaching one of: a) a second cover to the first body to selectively enclose a second side of the first chamber in a cover state, or b) a second body of an adjacent modular housing to the first chamber to create a joint chamber between a second chamber of the second body and the first chamber of the first body in an attached housing state.

19. The modular housing system of claim 18, further comprising a component holder mounted in at least one of the first chamber and the second chamber.

20. The modular housing system of claim 19, wherein the component holder includes a plate mounted to a pair of opposing members of the plurality of members of a respective body.

21. The modular housing system of claim 19, wherein the component holder includes a passage allowing at least part of the fiber cable to pass from the first chamber of the first body to the second chamber of the second body.

22. The modular housing system of claim 18, further comprising one of a third cover removably coupled to the first body to enclose a third side of the first chamber or an adapter panel removably coupled to the first body to enclose a third side of the first chamber.

23. The modular housing system of claim 18, wherein each cover includes a plunger-type coupling for mating with a corresponding opening of a respective body.

24. The modular housing system of claim 18, wherein each body includes a fastener opening for receiving a removable fastener for preventing the bodies from moving apart in the attached housing state.

25. The modular housing system of claim 18, further comprising an aligner including a first element on the first body for mating with a second element on an opposing side of the second body of the adjacent housing.

26. The modular housing system of claim 23, wherein the first element mates with a third element of the second cover in the cover state.

27. A method comprising:
providing a first modular housing and a second modular housing, each modular housing including:
a body including a plurality of members angled relative to one another to form a chamber therebetween, the body including an opening for receiving a fiber cable in the chamber,
a first cover removably coupled to the body to selectively enclose a first side of the chamber, and
an attachment feature on the body for pivotably attaching a second cover to the body for selectively enclosing a second side of the chamber;
removing the first cover from the body of the first modular housing;
removing the second cover from the body of the second modular housing; and
forming a first attached housing system by pivotally attaching the body of the first modular housing to the body of the second modular housing using the attachment feature of one of the first and second modular housings.

28. The method of claim 27, wherein each modular housing further includes a component holder mounted in a respective chamber.

29. The method of claim 28, further comprising inserting the fiber cable into a selected chamber of the body of one of the first and second modular housings, and passing at least part of the fiber cable from the selected chamber through a passage in the component holder of the other modular housing and into the chamber of the body of the other modular housing.

30. The method of claim 27, further comprising:
providing a third modular housing;
after forming the first attached housing system, removing a selected cover from the body of a selected housing of the first and second modular housings;
removing an opposing cover from the body of the third modular housing from that of the selected cover of the selected housing; and
forming a second attached housing system by pivotably attaching the body of the third modular housing to the body of the selected housing using an attachment feature of one of the third modular housing and the selected housing.
